(19) United States
(12) Patent Application Publication
(10) Pub. No.: US 2010/0049982 A1
(43) Pub. Date: Feb. 25, 2010

(54) DNSSEC BASE ROLLOUT

(75) Inventors: Daniel Migault, Issy Les Moulineaux (FR); Jean-Michael Combes, Issy Les Moulineaux (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 12/312,510

(22) PCT Filed: Oct. 26, 2007
(86) PCT No.: PCT/FR2007/052256

§ 371 Date: May 14, 2009

(30) Foreign Application Priority Data
Nov. 15, 2006 (FR) 0609987

(51) Int. Cl. H04L 9/32; G06F 21/20

(52) U.S. Cl. 713/176; 726/3; 726/22

(57) ABSTRACT

The invention relates to a method for accessing via a first device a predetermined piece of information duplicated in several server devices, each server device implementing a sub-assembly of safety mechanisms from a predetermined set of safety mechanisms in order to provide a predetermined safety level for accessing the predetermined piece of information, wherein said method comprises the following steps: a) transmission (40) by the first device of at least one access request adapted for receiving the list of safety mechanisms implemented by the server devices; b) transmission (46) by the first device to at least one of said server devices of an access request to the predetermined piece of information, said request using the safety mechanisms implemented by the and at least one of said server devices.

The invention relates to a method of and a system for access by a first device to a predetermined information item duplicated in several server devices, each server device implementing a subset of security mechanisms of a predetermined set of security mechanisms so as to provide a predefined level of security of access to the predetermined information item. The invention also relates to the first device and the associated server devices as well as to a computer program product implementing the access method.

In complex data networks and, particularly, computer networks of Internet type, it is noted that standards are evolving so as to take account of new security mechanisms intended to combat attacks endangering the stability and/or integrity of the networks.

A particular difficulty appears during the implementation of these new standards when they relate to modifications to be made to numerous pieces of equipment. Therefore, at least for a temporary period, it is necessary to provide mechanisms for cohabitation between equipment using an earlier version of the standards and equipment deploying the version of the standard as updated.

An example of this difficulty is found in the evolution of the DNS (Domain Name Service) standard to the DNSSEC standard (Secure DNS).

The DNS standard is a standard that is crucial for the operation of the Internet since it makes it possible to link a domain name with one or more IP addresses.

However, the DNS standard does not provide for any security mechanism. Thus, a malicious third party can, for example, intercept a DNS request asking for an IP address of a domain name corresponding, for example, to a banking site, and send back to the applicant an IP address corresponding to a false site imitating the banking site and making it possible to acquire the access codes of the clients thus duped.

The IETF has therefore formulated a secure version of the DNS standard, a version called DNSSEC, described in the IETF documents, RFC4033, RFC 4034 and RFC 4035.

The DNSSEC protocol relies on several security mechanisms:

A mechanism for authenticating the data of the server. It uses a signature (RRSIG) which allows a client to verify whether the information item has not been altered, and whether it does indeed originate from the legitimate server.

A mechanism for proving non-existence of a data item. The field NSEC2 makes it possible to rank the domain names as within a dictionary. As there is an order, if the requested domain name is not among the expected names, it is because it does not exist.

A mechanism for proving non-existence “hashed” of a data item. The field NSEC3 has the same functions as the field NSEC2, except that it does not return the plaintext data of the previous domain name and of the name of the following domain. It returns a key for hashing these names. This prevents the possibility of the area being listed.

A confidence chain mechanism. This mechanism makes it possible to pass from a level of the hierarchy of the DNS servers to a lower level without losing confidence.

Furthermore, associated with DNSSEC, the DNS protocol comprises certain security mechanisms such as:

TSIG which makes it possible to encrypt the communications with the aid of a shared key.

SIG(0) which allows, inter alia, the authentication of the client by an asymmetric key system.

These mechanisms generally enable the DNS system to be made secure.

These security mechanisms generate costs and constraints. For example, in certain cases, the use of security mechanisms does not allow dynamic updating.

Thus, it is desirable to be able to favor certain mechanisms with respect to others as a function of requirements.

Moreover, to allow progressive evolution of the network, it is desirable to allow access to the DNS service to clients that are not yet, or that are partially, implementing the DNSSEC protocol.

It is thus desirable to have a method and a system for accessing data protected by security mechanisms in which it is possible to choose the security mechanisms implemented.

When several servers offer the same data item with different implementations of the access security mechanisms, it is also desirable to have a method and a system which make it possible to choose the server as a function of the access mechanisms implemented by said server.

A subject of the invention is therefore a method of access by a first device to a predetermined information item duplicated in several server devices, each server device implementing a subset of security mechanisms of a predetermined set of security mechanisms so as to provide a predefined level of security of access to the predetermined information item, said method comprising the steps of:

a) sending by the first device of at least one access request adapted for receiving the list of security mechanisms implemented by the server devices,

b) sending by the first device to at least one of said server devices of a request for access to the predetermined information item, said request using the security mechanisms implemented by the at least one of said server devices.

Other characteristics and particular embodiments are:

it comprises, after step a) of sending at least one request, a step a1) of selection by the first device of a server device having implemented a predetermined subset of security mechanisms, thereby advantageously making it possible to select a server device according to criteria specific to the first device.

a central server device comprising a list referencing the server devices and the subset of security mechanisms implemented by each server device, step a) consists in sending an access request directed towards the central server device, thereby advantageously making it possible to obtain with a single request the list of server devices and of their security mechanisms.

the list referencing the server devices furthermore comprising at least one reference to a server device not comprising the predetermined information item, in response to the access request of step a), the central server device dispatches to the first device a sub-list of said list, said sub-list comprising only references to the server devices comprising the predetermined information item, thereby advantageously making it possible to limit the quantity of information items transferred.

the server devices being DNS servers at least one of which implements all or part of the security mechanisms of the DNSSEC standard and the central server device being a DNS server of higher level in the DNS hierarchy, the base of whose DNS servers comprises at least one field describing the security mechanisms of the DNSSEC standard that are implemented by each DNS server, step a) consists in sending a DNS request of type A so as to determine the IP address corresponding to a DNS address at the DNS server of higher level and the response of the DNS server of higher level to this request consists of a DNS response of type NS with which are concatenated the fields describing the security mechanisms of the DNSSEC standard that are implemented for each DNS server whose address is transmitted in the response of type NS, thereby advantageously making it possible to select the DNS server implementing the chosen mechanisms of the DNSSEC protocol.

the server devices being DNS servers at least one of which implements all or part of the security mechanisms of the DNSSEC standard, step a) consists of a DNS request for acquiring the characteristics of a server device which is addressed to said server device, to which said server device responds by transmitting to the first device a field describing the security mechanisms of the DNSSEC standard that are implemented by said server device, thereby advantageously making it possible to ascertain the DNSSEC security mechanisms implemented by the DNS server.

Another subject of the invention is a device for access to a predetermined information item duplicated in several server devices, each server device implementing a subset of security mechanisms of a predetermined set of security mechanisms so as to provide a predefined level of security of access to the predetermined information item, characterized in that it comprises:

a) means for sending at least one access request, which request is adapted for receiving the list of security mechanisms implemented by the server devices,

b) means for sending to at least one of said server devices a request for access to the predetermined information item, said request using the security mechanisms implemented by the at least one of said server devices.

Another subject of the invention is a server device implementing a subset of security mechanisms of a predetermined set of security mechanisms so as to provide a predefined level of security of access to a predetermined information item, characterized in that it comprises:

a) means for receiving at least one access request by a first device, which request is adapted for receiving the list of security mechanisms implemented by said server device,

b) means for dispatching in response to the access request the list of security mechanisms implemented,

c) means for receiving a request for access to the predetermined information item sent by the first device, said request using the security mechanisms implemented by said server device.

Another subject of the invention relates to a system for access to a predetermined information item comprising an access device according to the invention and several server devices according to the invention.

Another subject of the invention is a computer program comprising program code instructions for executing the steps of the above method when said program is executed on a computer.

The invention will be better understood on reading the description which follows, given solely by way of example and with reference to the appended figures in which:

FIG. 1 is a schematic view of an access system according to an embodiment of the invention;

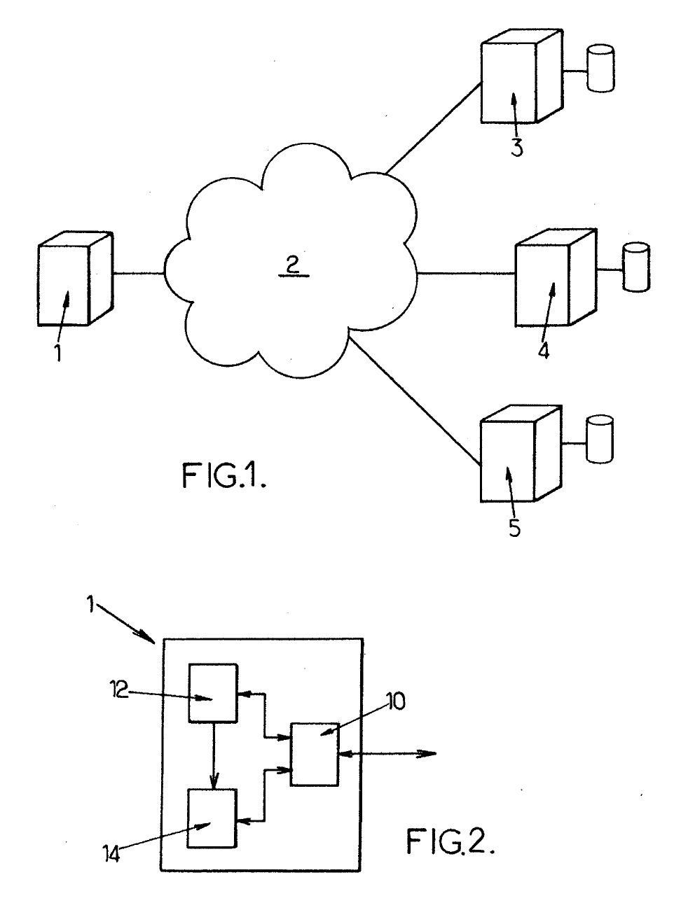

FIG. 2 is a schematic view of a first device of the system of FIG. 1;

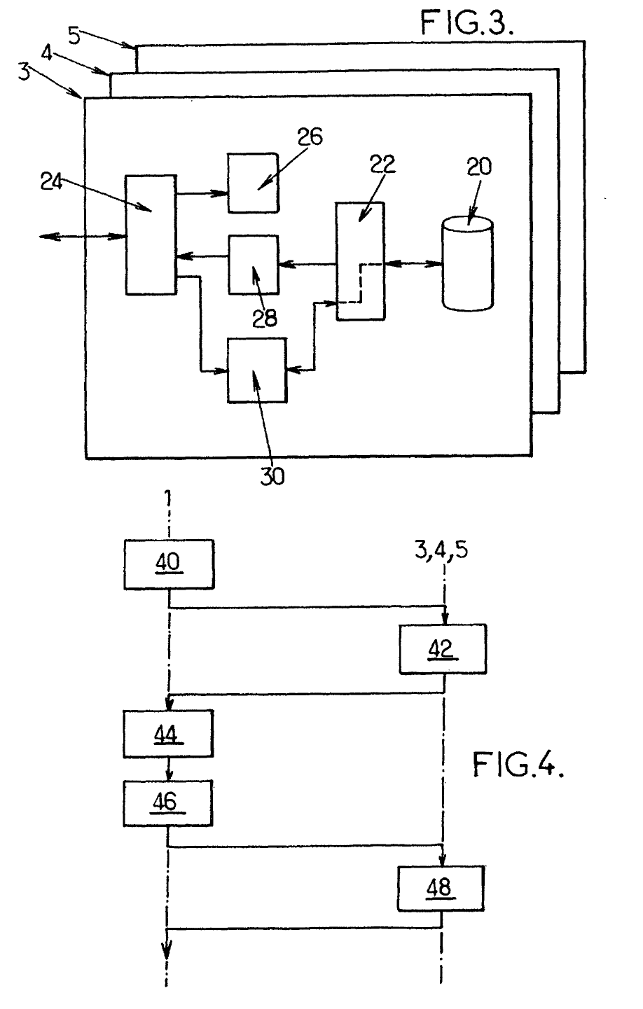

FIG. 3 is a schematic view of a server device of the system of FIG. 1;

FIG. 4 is a flowchart of a first embodiment of the method according to the invention;

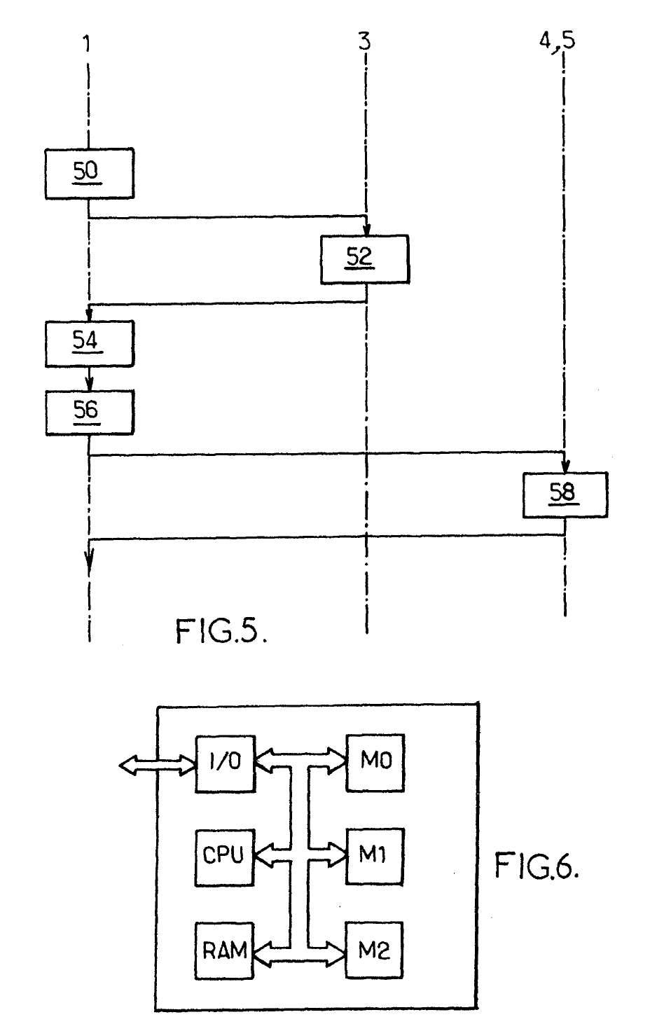

FIG. 5 is a flowchart of a second embodiment of the method according to the invention; and

FIG. 6 is a schematic view of a computer employing a program implementing an embodiment of the method according to the invention.

With reference to FIG. 1, a first device 1 is connected by way of a data network 2 to server devices 3, 4, 5.

By way of illustration, the first device 1 is a DNS client, for example a recursive cache server, and the server devices 3, 4 and 5 are DNS servers. As is well known to the person skilled in the art, the DNS servers are organized as a hierarchy of servers corresponding to the hierarchy of domain names. For example, the DNS server 3 is the server having authority over the area “.fr”, the DNS server 4 is the server having authority over the domain “francetelecom.fr” and the DNS server 5 is the server having authority over the domain “gouv.fr”.

The hierarchy between DNS servers is particularly illustrated during conventional resolution of the domain name. Let us assume that the DNS client 1 wishes to ascertain the IP address of the address www.francetelecom.fr.

The DNS client 1 dispatches a request relating to this domain to the root server (not represented). The latter sends it back the IP address of the DNS server exercising authority over the area “.fr”, viz. the DNS server 3. The DNS client 1 then dispatches a request to resolve the domain www.francetelecom.fr to the DNS server 3. The latter sends it back the IP address of the DNS server exercising authority in respect of the domain “francetelecom.fr”, viz. the server 4. The DNS client 1 then dispatches a resolution request in respect of www.francetelecom.fr to the DNS server 4. The latter returns the IP address of the corresponding Web server, which IP address is transferred by the DNS client 1 to the HTTP client that sent the initial request so that the latter can interrogate the Web server.

The first device 1 comprises, FIG. 2, means 10 for connecting to the data network 2.

It comprises means 12 for sending at least one access request which is adapted for receiving a list of security mechanisms implemented by the server devices 3, 4, 5.

It also comprises means 14 for sending to at least one of the server devices 3, 4, 5 a request for access to a predetermined information item. The access request is such that it uses the security mechanisms implemented.

The server devices 3, 4, 5 comprise, FIG. 3, means 20 for storing a predetermined information item. This is, for example, a database of the information items related to the DNS protocol.

Access to this information item is controlled by security mechanisms 22 defining a level of security of access to this information item.

The server devices 3, 4, 5 comprise means 24 for connecting to the data network 2.

Reception means 26 are connected to the connection means 24.

The reception means 26 are adapted for receiving an access request coming from the first device 1. This access request comprises an application asking for details regarding the list of security mechanisms 22 implemented. To respond to this request, the server device 3, 4, 5 comprises means 28 for dispatching the list of security mechanisms 22 implemented.

The server device 3, 4, 5 furthermore comprises means 30 for receiving a request for access to the predetermined information item, which request is sent by the first device 1. This request uses the access security mechanisms 22 to access the information item.

The operation of the system will be explained in conjunction with FIG. 4.

It should be noted, at the outset, that in order to allow proper understanding of the relationships between the various entities of the system, the flowcharts of FIGS. 4 and 5 present several columns, each column representing an entity and each task being distributed in a column as a function of the entity which executes it.

In step 40, the first device 1 sends at least one request destined for at least one of the server devices 3, 4, 5.

In step 42, each server device 3, 4, 5 interrogated responds by dispatching a list of security mechanisms implemented.

In step 44, optional, the first device 1 selects one of the server devices 3, 4, 5 as a function of the security mechanisms implemented by the latter. For example, the first device 1 compares the list of security mechanisms implemented by each server device with a predetermined subset of security mechanisms.

In step 46, the first device sends a request for access to the information item stored in the storage means 20. This request is intended for the server device 3, 4, 5 selected and complies with the security mechanisms implemented by this server device 3, 4, 5.

In step 48, the security mechanisms having been correctly activated, the server device 3, 4, 5 dispatches the requested information item to the first device 1.

In a second embodiment, one of the server devices 3, 4, 5, for example the server device 3, has a role of central server device comprising a list referencing the server devices 4, 5 as well as the subset of security mechanisms implemented by each server device 4, 5.

In step 50, the first device 1 then sends its request destined for the central server device 3.

In step 52, the response of the central device 3 comprises a list of server devices 4, 5 as well as the security mechanisms implemented.

It should be noted that, in a particular embodiment, when some of the server devices 4, 5 comprise the predetermined information item and others do not, the list dispatched by the central server device 3 comprises only the server devices containing the predetermined information item.

The first device 1 selects in step 54 a server device 4, 5 as indicated in the previous embodiment then sends in step 56 the request for access to the predetermined information item destined for the server device 4, 5 selected.

The latter dispatches in step 58 the predetermined information item to the first device 1.

By way of illustration, the example of the DNS servers presented above will be used hereinafter to show an example of the operation of the access method.

The terminology used hereinafter employs the usual definitions of the fields and requests of the DNS, or DNSSEC, protocol such as they exist in the IETF standardization documents.

A new field SEC is created to describe the DNSSEC security mechanisms implemented.

A new type, NS*, similar to the former type NS, makes it possible to contain security information items implemented by the server. The field SEC is used during the resolution of the domain name in such a way that the client can decide as a function of the security mechanisms, as soon as the server name has been ascertained, regarding the security parameters put in place by the server. The parameter SEC pertains only to security mechanisms related to a domain name.

A field HSEC contains the server's security information items. This field makes it possible to characterize the security mechanisms related to an IP address. This field also makes it possible to ascertain the security mechanisms of a server simply on the basis of its domain name (i.e. its name), and not of the domain name that it administers, (i.e. the share of the naming space that it administers). Specifically, the field HSEC makes it possible to give the security mechanisms related to the machine, i.e. to an IP address.

The field SEC consists of a certain number of bytes (2 for example). Each bit represents a mechanism. The bit is set to 1 if the mechanism is enabled and to 0 otherwise. The field SEC is described, for example, in the following manner:

Bit 0: Authentication/integrity (SIG)

Bit 1: Proof of non-existence (NSEC)

Bit 2: Authentication of the client (TSIG)

Bit 3: Agreement with the client's request SIG(0))

Bit 4: Confidence chain (DS)

. . .

Taking the example of the conventional DNS, the field SEC has the value 0. Within the framework of the traditional DNSSEC the field SEC has the value 1100 1000=C8 (Hexadecimal).

The field HSEC is dedicated to hosting information items relating to the domain name. The field HSEC is hosted under the domain name relating to the server. The field HSEC then possesses the value of the security parameter SEC.

The structure of the field HSEC is for example, Textual Representation:

owner class ttl HINFO cpu os

Example:

grizzly.movie.edu. IN HSEC 0×7

Binary Representation:

HINFO code type: HSEC_VALUE

SEC

where:

SEC Value of the security field

Again employing the field SEC, the field NS* has the following layout:

Textual Representation:

owner class ttl NS name-server-dname

Example:

movie.edu. IN NS* terminator.movie.edu SEC

Binary Representation:

NS code type: NS*_CODE

NSDNAME
SEC

Where:

NSDNAME Domain name specifying a host which manages the DNS area; and

SEC Security parameter

The structure of a DNS file is, for example, the following

| movie.edu. IN SOA terminator.movie.edu. | |
|---|---|
| al.robocop.movie.edu. ( | |
| 1 | ; serial number |
| 10800 | ; Refreshing after 3 hours |
| 3600 | ; Replay after one hour |
| 604800 | ; Expires after one week |
| 86400 | ; minimum TTL of 1 day |

| ; | |
|---|---|
| ; Servers of names | |
| movie.edu. IN NS* terminator.movie.edu. \|SEC | |
| movie.edu. IN NS* wormhole.movie.edu. \|SEC | |
| ; | |
| ; Addresses for the canonical names | |
| ; | |
| localhost.movie.edu. | IN A 127.0.0.1 |
| robocop.movie.edu. | IN A 192.249.249.2 |
| terminator.movie.edu. | IN A 192.249.249.3 |
| | IN HSEC SEC |
| diehard.movie.edu. | IN A 192.249.249.4 |
| misery.movie.edu. | IN A 192.253.253.2 |
| shining.movie.edu. | IN A 192.253.253.3 |
| carrie.movie.edu. | IN A 192.253.253.4 |
| wormhole.movie.edu. | IN A 192.249.249.1 |
| | IN HSEC SEC |
| wormhole.movie.edu. | IN A 192.253.253.1 |
| ; | |
| ; Alias | |
| ; | |

| | |
|---|---|
| bigt.movie.edu. | IN CNAME terminator.movie.edu. |
| dh.movie.edu | IN CNAME diehard.movie.edu. |
| wh.movie.edu | IN CNAME wormhole.movie.edu. |

| ; | |
|---|---|
| ; Specific names of the interfaces | |
| wh249.movie.edu | IN A 192.249.249.1 |
| wh253.movie.edu | IN A 192.253.253.1 |

A secure DNS resolution then comprises, FIG. 5, in step 50 a resolution application request of type A to which the DNS server 3 responds in step 52 by a field NS*, that is to say a field NS with which is concatenated the field SEC containing the DNSSEC security mechanisms of the corresponding server.

Thus, the DNS client 1 has the information necessary for choosing in step 54 the DNS server having the DNSSEC security mechanisms adapted to its requirement.

When the DNS client 1 wishes to ascertain the security mechanisms implemented by a particular DNS server, FIG. 3, it sends at 40 a request for access to the field HSEC of this server. This allows it to adapt its request for access to the information item as a function of the security mechanisms implemented without having to apply for the whole set of information items corresponding to the whole set of DNS servers.

It is understood that the access method can be implemented by a computer program product downloadable from a communication network and/or recorded on a support readable by computer and/or executable by a processor such as represented in FIG. 6 and comprising an arithmetic and logic unit CPU, various registers M0, M1, M2, M3 and RAM memories as well as inputs/outputs I/O.

1. A method of access by a first device (1) to a predetermined information item duplicated in several server devices (3, 4, 5), each server device implementing a subset of security mechanisms of a predetermined set of security mechanisms so as to provide a predefined level of security of access to the predetermined information item, said method comprising the steps of:
a) sending (40, 50) by the first device of at least one access request adapted for receiving the list of security mechanisms implemented by the server devices,
b) sending (46, 56) by the first device to at least one of said server devices of a request for access to the predetermined information item, said request using the security mechanisms implemented by the at least one of said server devices.

2. The method as claimed in claim 1, characterized in that it comprises, after step a) of sending at least one request, a step a1) of selection (44, 54) by the first device of a server device having implemented a predetermined subset of security mechanisms.

3. The method as claimed in claim 2, characterized in that a central server device comprising a list referencing the server devices and the subset of security mechanisms implemented by each server device, step a) consists in sending (50) an access request directed towards the central server device.

4. The method as claimed in claim 3, characterized in that the list referencing the server devices furthermore comprising at least one reference to a server device not comprising the predetermined information item, in response to the access request of step a), the central server device dispatches (52) to the first device a sub-list of said list, said sub-list comprising only references to the server devices comprising the predetermined information item.

5. The method as claimed in claim 4, characterized in that the server devices being DNS servers at least one of which implements all or part of the security mechanisms of the DNSSEC standard and the central server device being a DNS server of higher level in the DNS hierarchy, the base of whose DNS servers comprises at least one field describing the security mechanisms of the DNSSEC standard that are implemented by each DNS server, step a) consists in sending a DNS request of type A so as to determine the IP address corresponding to a DNS address at the DNS server of higher level and the response of the DNS server of higher level to this request consists of a DNS response of type NS with which are concatenated the fields describing the security mechanisms of the DNSSEC standard that are implemented for each DNS server whose address is transmitted in the response of type NS.

6. The method as claimed in claim 1, characterized in that the server devices being DNS servers at least one of which implements all or part of the security mechanisms of the DNSSEC standard, step a) consists of a DNS request for acquiring the characteristics of a server device which is addressed to said server device, to which said server device responds by transmitting to the first device a field describing the security mechanisms of the DNSSEC standard that are implemented by said server device.

7. A device for access to a predetermined information item duplicated in several server devices (3, 4, 5), each server device implementing a subset of security mechanisms of a predetermined set of security mechanisms so as to provide a predefined level of security of access to the predetermined information item, characterized in that it comprises:
a) means (12) for sending at least one access request, which request is adapted for receiving the list of security mechanisms implemented by the server devices,
b) means (14) for sending to at least one of said server devices a request for access to the predetermined information item, said request using the security mechanisms implemented by the at least one of said server devices.

8. A server device implementing a subset of security mechanisms of a predetermined set of security mechanisms so as to provide a predefined level of security of access to a predetermined information item, characterized in that it comprises:
a) means (26) for receiving at least one access request by a first device, which request is adapted for receiving the list of security mechanisms implemented by said server device,
b) means (28) for dispatching in response to the access request the list of security mechanisms implemented,
c) means (30) for receiving a request for access to the predetermined information item sent by the first device, said request using the security mechanisms implemented by said server device.

9. A system for access to a predetermined information item, comprising:
an access device as claimed in claim 7,
several server devices as claimed in claim 8.

10. A computer program comprising program code instructions for executing the steps of the method as claimed in any one of claims 1 to 6 when said program is executed on a computer.
